(19) United States
(12) Patent Application Publication
(10) Pub. No.: US 2023/0157434 A1
(43) Pub. Date: May 25, 2023

(54) A Gem Embedded Detachably Attached Fingertip Ornament and Process Thereof

(71) Applicants: Meenaben Manishkumar Vaghani, Mumbai (IN); Manishkumar Lavjibhai Vaghani, Mumbai (IN)

(72) Inventors: Radha Vimal Vaghani, Maharashtra (IN); Vimal Amarshibhai Vaghani, Mumbai (IN); Tejal Dharmeshbhai Vaghani, Mumbai (IN); Dharmeshbhai Lavjibhai Vaghani, Mumbai (IN)

(21) Appl. No.: 17/804,633

(22) PCT Filed: Feb. 26, 2020
(86) PCT No.: PCT/IB2020/051631

§ 371 Date: May 31, 2022

(30) Foreign Application Priority Data
May 2, 2020 (IN) 202021004931

(51) Int. Cl. A45D 31/00; G01B 11/24; G05B 19/4099

(52) U.S. Cl. CPC A45D 31/00; G01B 11/24; G05B 19/4099; G05B 2219/49008

(57) ABSTRACT

The present invention relates is the gem embedded detachably attached fingertip ornament and process thereof. The gem embedded detachably attached fingertip ornament comprised of a plurality of metallic plates, plurality of glue types, and plurality of diamonds having different sizes and shapes. The metallic plates are pseudo nail of different shapes and sizes according to the sizes and shapes of nail and designed and patterns selected by the user. The plurality of metallic plates are of different sizes and made up of gold, platinum, silver, bronze, iron, aluminum, copper, titanium, acrylic, plastic and glass. The plurality of glue types are of aloe-vera Glue, corn starch glue, natural glue, eyelash glue, and glue made from vinyl acetate monomer. The plurality of diamonds are of multiple sizes which further comprise of a variety of shapes.

### CROSS-REFERENCES TO RELATED APPLICATIONS

This Non-Provisional Utility application claims the benefit of and priority to PCT Application Serial No. PCT/IB20201051631, filed Feb. 26 2020, entitled “A Gem Embedded Detachably Attached Fingertip Ornament and Process thereof,” which claims the benefit of and priority to Indian Patent Application Serial No. 202021004931, filed Feb. 5, 2020, entitled “A Gem Embedded Detachably Attached Fingertip Ornament and Process thereof,” the entire contents of both applications of which are hereby incorporated herein by reference.

### FIELD OF THE INVENTION

The present invention generally relates to the field of apparatus and process for jewelry and ornament for decorating finger nail and more particularly the present invention relates to a gem embedded detachably attached fingertip ornament and process thereof.

### BACKGROUND

It is well known that decorating body parts and wearing jewelry is fashionable at the present time. Regardless of men and women, people wear different kind of jewelry. One of common jewelry or fashionable is changing color of fingertips and/or nails. The women polish, decorate their fingertip to enhance the femininity and beauty.

With the increasing demands of modern look of nails many different type of nails ornament are available in the market and manufacturing of new design of nails ornament have adapted in form to satisfy peoples' different lifestyle. Almost every shopping area has a beauty salon catering to providing, among other beauty related services, artificial or false nails to its customers. In large part, people, especially women, desire artificial nails for decorative and fashionable looks.

A number of different types of fingertip and/or nail ornament are available prior art. For example, the following patents are provided for their supportive teachings and are all incorporated by reference: Prior art document, JP2005288053A discloses a false nail ornament having attachment means that is detachably attached to a false nail having no attachment means for the ornament, and is attached to a body such as an attachment member for passing a pendant and/or a brooch or earring Jewelry accessories having jewelry members for making them. An object of the present invention is to provide an accessory such as a pendant top or an accessory such as a brooch, which is provided with an attachment member that can detachably attach the artificial nail without processing the artificial nail and providing an attachment means is there.

Another prior art document, US20110087351A1 discloses a method and system for designing and making one or more artificial nails customized to fit one or more real nails of a client. Additionally, the invention enables customization or selection of decorative patterns for the artificial nail. The process begins with scanning one or more nails of the client with a scanner. The scanned image is then converted into a virtual three-dimensional surface model for each real nail. The virtual three-dimensional model of each nail is displayed on a monitor of a workstation. The user, e.g. a beautician at a beauty salon, using the workstation and in consultation with the client, designs a customized artificial nail using the virtual three-dimensional model of the real nail. At the user command, the customized design of the artificial nail is then sent to a numerically controlled (NC) or a similar machine, where the artificial nail is made in accordance with the custom design. The artificial nail may be made from acrylic materials or other suitable materials.

Still another prior art document, US20140345636A1 discloses a nail tip comprising of an artificial nail tip having a top surface and a bottom surface. The artificial nail tip has a plurality of decorative particles covering the entire top surface of the artificial nail tip and a base adhesive to attach the plurality of decorative particles to the top surface of the artificial nail tip and to other pluralities of decorative particles.

Yet another prior art document, JP2009247484A discloses a gem embedded artificial nail with high grade feeling by which a gem can be precisely embedded in a predetermined location, depth, and inclination using an artificial nail chip and the brilliancy of a gem itself can be utilized because the upper face side of the gem is not covered with gel or adhesive and exposed, and a method for manufacturing the same. The gem embedded artificial nail comprises the gel cut into a shape such that an embedded portion tapers to the lower surface distal end side, and the artificial nail chip 1 in which an attaching groove with the shape corresponding to the embedded portion is formed, wherein the adhesive is applied to the attaching groove surface, the embedded portion is pushed into the attaching groove, and the embedded portion is embedded into the attaching groove through the adhesive with a film shape such that the embedded portion surface closely contacts with the attaching groove surface.

Still another prior art document, JP4217754B1 discloses a method for decorating a nail or an artificial nail capable of attaching a jewel whose lower part has a substantially inverted conical shape to the nail or an artificial nail reliably and attractively. Moreover, the decoration method of the nail claw or artificial nail which can be attached to a nail claw or an artificial nail easily and reliably a several jewel with different magnitude sizes is provided. Further, a nail or artificial nail sticking film used in the decoration method, a nail or artificial nail rotary cutting tool used in the decoration method, and a nail or artificial nail rotary hand equipped with the rotary cutting tool Provide a piece. A method for decorating a nail or an artificial nail by attaching a jewel having a lower part in a substantially inverted conical shape to a nail N or an artificial nail, wherein the lower part of the jewel is attached to the nail or an artificial nail. A mortar-shaped recess is formed by the rotary cutting tool in accordance with the shape of the above, and after applying an adhesive to the recess, the lower part of the jewel is fitted into the recess and bonded.

Final prior art document, US20070084478A1 discloses Jewelry for fingernails and toenails that is removable but securely attachable to a natural or artificial nail, such as false fingernails. The fingernail jewelry comprises a nail plate that attaches to the distal end and/or sides of the nail. The nail plate has an upper portion and a lower portion defining a cavity at the first end of the nail plate. The distal end and/or sides of the nail is received in the cavity. In one embodiment, the cavity tightly holds the nail to prevent the fingernail jewelry from being easily dislodged. In another embodiment, an adhesive secures the nail plate to the nail. In yet another embodiment, connectors pass through the nail plate and thread ably attach to the nail. The connector heads are incorporated into a design element. In a further embodiment, stud members extend downward from the nail plate into apertures on the nails.

However, above mentioned references and many other similar references has one or more of the following shortcomings: (a) repetitively cleaning; (b) Used and throw; (c) Same size and design; (d) Nail damaging; and (e) Single color.

The present application addresses the above mentioned concerns and short comings with regard to providing a gem embedded detachably attached fingertip ornament and process thereof.

### SUMMARY

In the view of the foregoing disadvantages inherent in the known types of metallic jewelry for nail and/or fingertips present in the prior art, the present invention provides a gem embedded detachably attached fingertip ornament and process thereof for providing fashionable, durable ornament and jewelry. As such, the general purpose of the present invention, which will be described subsequently in greater detail, is to provide a gem embedded detachably attached fingertip ornament and process thereof which has all the advantages of the prior art and none of the disadvantages.

The main aspect of the present invention is to provide a gem embedded detachably attached fingertip ornament and process thereof. The gem embedded detachably attached fingertip ornament comprised of plurality of metallic plate, plurality of glue type, and plurality of diamond of different size and shape. The metallic plate are pseudo nail of different shape and size according to the size and shape of nail and designed and pattern selected by the user.

Another aspect of the present invention is to provide the plurality of metallic plate which are of different size and made up of gold, platinum, silver, bronze, iron, aluminum, copper, titanium, acrylic, plastic and glass.

Yet another aspect of the present invention is to provide plurality of glue type which are aloe-vera Glue, corn starch glue, natural glue, eyelash glue, and glue made from vinyl acetate monomer.

Still another aspect of the present invention is to provide plurality of diamond which are of multiple size which further comprise of round, star, pear, marquise, emerald, princess, baguette, heart, illusion, jade, HPHT (high-pressure high-temperature), cubic zirconia, lab grown, treated, fancy shape, moissanite, rose cut, oval, triangle, rectangle, hexagonal and octagonal.

Yet another aspect of the present invention is to provide a process for designing the gem embedded detachably attached fingertip ornament comprise of following steps:
i. Scanning of nail of a user by a scanner from different direction,
ii. Collecting image from step (i) and producing a three dimensional image and/or nail in computer implemented methods.
iii. Transmitting the three dimensional image produced in step (ii) to a server,
iv. Accessing the three dimensional image from server by a designer,
v. Implementation of metallic plate on the three dimensional image of nail in a computer implemented methods,
vi. Implementation of plurality of design, pattern and different shape, size gem on the metallic plate of step (v) in the computer implemented methods,
vii. Selecting required design, gem and metallic plate for the three dimensional image of nail in the computer implemented methods,
viii. Manufacturing of selected design, gem for the metallic plate;
ix. Setting said gem on the metallic plate; and
x. Adding glue to back side of the metallic plate after steps (viii).

Still another aspect of the present invention is to provide the server which is cloud server and plurality of three dimensional patterns, design and three dimensional diamond image are stored.

Yet another aspect of the present invention is to provide the scanner which can be laser scanner and any scanner with mobile objects.

Final aspect of the present invention is to provide the fashionable, durable, self-design metallic fingertip nail ornament with plurality of gems mounted on it.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

These together with other objects of the invention, along with the various features of novelty which characterize the invention, are pointed out with particularity in the disclosure. For a better understanding of the invention, its operating advantages and the specific objects attained by its uses, reference should be had to the accompanying drawings and descriptive matter in which there are illustrated preferred embodiments of the invention.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 depicts the schematic view of a specific gem embedded detachably attached fingertip ornament.

FIG. 2 depicts the flow chart for process of design and manufacturing of gem embedded detachably attached fingertip ornament.

FIG. 3 depicts the schematic view of one embodiment of the present invention.

FIG. 4 depicts the schematic view of another embodiment of the present invention.

FIG. 5 depicts the schematic view of another embodiment of the present invention.

FIG. 6 depicts the schematic view of another embodiment of the present invention.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that the embodiments may be combined, or that other embodiments may be utilized and that structural and logical changes may be made without departing from the spirit and scope of the present invention. The following detailed description is, therefore, not to be taken in a limiting sense, and the scope of the present invention is defined by the appended claims and their equivalents.

The present invention is described in brief with reference to the accompanying drawings. Now, refer in more detail to the exemplary drawings for the purposes of illustrating non-limiting embodiments of the present invention.

As used herein, the term “comprising” and its derivatives including “comprises” and “comprise” include each of the stated integers or elements but does not exclude the inclusion of one or more further integers or elements.

As used herein, the singular forms “a”, “an”, and “the” include plural referents unless the context clearly dictates otherwise. For example, reference to “a device” encompasses a single device as well as two or more devices, and the like.

As used herein, the terms “for example”, “like”, “such as”, or “including” are meant to introduce examples that further clarify more general subject matter. Unless otherwise specified, these examples are provided only as an aid for understanding the applications illustrated in the present disclosure, and are not meant to be limiting in any fashion.

As used herein, the terms “may”, “can”, “could”, or “might” be included or have a characteristic, that particular component or feature is not required to be included or have the characteristic.

Exemplary embodiments will now be described more fully hereinafter with reference to the accompanying drawings, in which exemplary embodiments are shown. These exemplary embodiments are provided only for illustrative purposes and so that this disclosure will be thorough and complete and will fully convey the scope of the invention to those of ordinary skill in the art. The invention disclosed may, however, be embodied in many different forms and should not be construed as limited to the embodiments set forth herein.

Various modifications will be readily apparent to persons skilled in the art. The general principles defined herein may be applied to other embodiments and applications without departing from the spirit and scope of the invention. Moreover, all statements herein reciting embodiments of the invention, as well as specific examples thereof, are intended to encompass both structural and functional equivalents thereof. Additionally, it is intended that such equivalents include both currently known equivalents as well as equivalents developed in the future (i.e., any elements developed that perform the same function, regardless of structure). Also, the terminology and phraseology used is for the purpose of describing exemplary embodiments and should not be considered limiting. Thus, the present invention is to be accorded the widest scope encompassing numerous alternatives, modifications and equivalents consistent with the principles and features disclosed. For purpose of clarity, details relating to technical material that is known in the technical fields related to the invention have not been described in detail so as not to unnecessarily obscure the present invention.

Thus, for example, it will be appreciated by those of ordinary skill in the art that the diagrams, schematics, illustrations, and the like represent conceptual views or processes illustrating systems and methods embodying this invention. The functions of the various elements shown in the figures may be provided through the use of dedicated hardware as well as hardware capable of executing associated software. Similarly, any switches shown in the figures are conceptual only. Their function may be carried out through the operation of program logic, through dedicated logic, through the interaction of program control and dedicated logic, or even manually, the particular technique being selectable by the entity implementing this invention. Those of ordinary skill in the art further understand that the exemplary hardware, software, processes, methods, and/or operating systems described herein are for illustrative purposes and, thus, are not intended to be limited to any particular named element.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

All methods described herein can be performed in any suitable order unless otherwise indicated herein or otherwise clearly contradicted by context. The use of any and all examples, or exemplary language (e.g., “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Various terms as used herein are shown below. To the extent a term used in a claim is not defined below, it should be given the broadest definition and persons in the pertinent art have given that term as reflected in printed publications and issued patents at the time of filing.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all groups used in the appended claims.

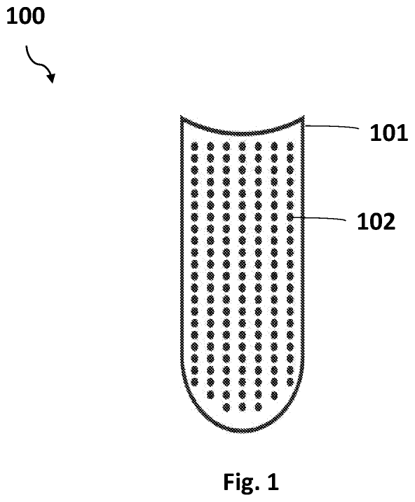

The main embodiment of the present invention is to provide a gem embedded detachably attached fingertip ornament and process thereof. FIG. 1 depicts the schematic view of a specific gem embedded detachably attached fingertip ornament. The gem embedded detachably attached fingertip ornament comprised of plurality of metallic plate 101, plurality of glue type, and plurality of diamond 102 of different size and shape. The metallic plate 101 are pseudo nail of different shape and size according to the size and shape of nail and designed and pattern selected by the user. The plurality of metallic plate 101 are of different size and made up of gold, platinum, silver, bronze, iron, aluminum, copper, titanium, acrylic, plastic and glass. The plurality of glue type are of aloe-Vera Glue, corn starch glue, natural glue, eyelash glue, and glue made from vinyl acetate monomer. The plurality of diamond in the present invention which are of multiple size which further comprise of round, star, pear, marquise, emerald, princess, baguette, heart, illusion, jade, HPHT (high-pressure high-temperature), cubic zirconia, lab grown, treated, fancy shape, moissanite, rose cut, oval, triangle, rectangle, hexagonal and octagonal. The gem or diamond can be set on metallic plate by various type such as prong, shared prong, bezel, half bezel, channel, pave, bar, beat set, bright-cut, flush-cut, scalloped-set, fishtail setting.

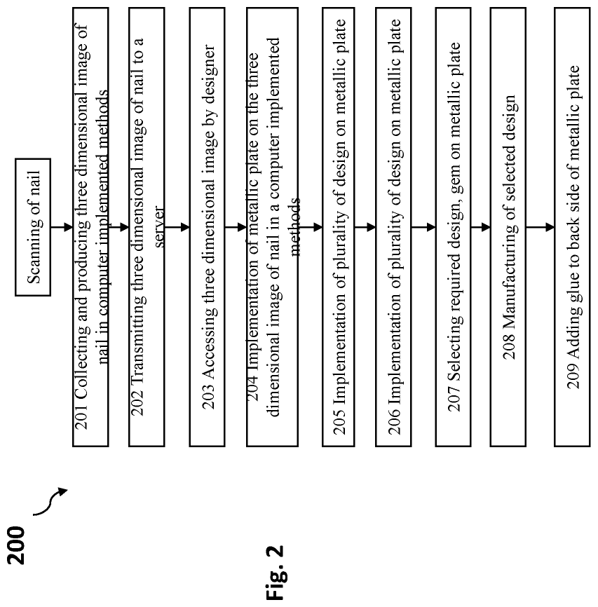

FIG. 2 depicts the flow chart for process of design and manufacturing of gem embedded detachably attached fingertip ornament. The process for designing the gem embedded detachably attached fingertip ornament comprise of following steps:
i. Scanning of nail of a user by a scanner from different direction,
ii. Collecting image from step (i) and producing a three dimensional image and/or nail in computer implemented methods.
iii. Transmitting the three dimensional image produced in step (ii) to a server,
iv. Accessing the three dimensional image from server by a designer,
v. Implementation of metallic plate on the three dimensional image of nail in a computer implemented methods,
vi. Implementation of plurality of design, pattern and different shape, size gem on the metallic plate of step (v) in the computer implemented methods,
vii. Selecting required design, gem and metallic plate for the three dimensional image of nail in the computer implemented methods,
viii. Manufacturing of selected design, gem for the metallic plate;
ix. Setting said gem on the metallic plate; and
x. Adding glue to back side of the metallic plate after steps (viii).

The server in the present invention cloud server and can optionally any database which can store plurality of three dimensional pattern, design and three dimensional diamond image. The server store the image capture or scanned by the scanner and any scanner with mobile objects. The scanner in the present invention can be laser scanner and any scanner with mobile objects. The mobile objects are mobile phone, wireless communicator with scanning capability, camera etc. The gem or diamond can be set on metallic plate by various type such as prong, shared prong, bezel, half bezel, channel, pave, bar, beat set, bright-cut, flush-cut, scalloped-set, fishtail setting.

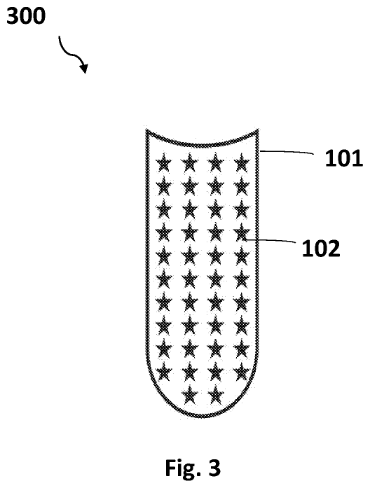

Another embodiment of the present invention provides a gem embedded detachably attached fingertip ornament with plurality of star shaped diamond attached to it. FIG. 3 shows the schematic view of one embodiment of the present invention. The gem embedded detachably attached fingertip ornament have at least 40 diamond mounted on the metallic plate.

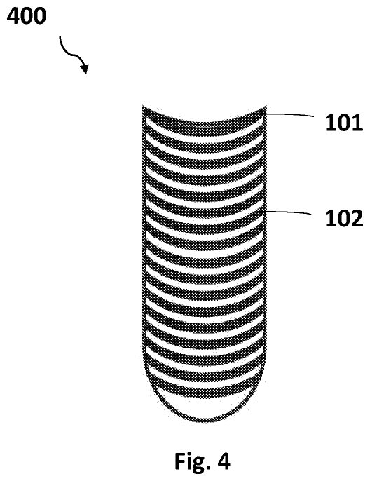

Yet another embodiment of the present invention provides a gem embedded detachably attached fingertip ornament with plurality of curve strip pattern with diamond attached to it. FIG. 4 shows the schematic view of curve strip pattern with diamond attached fingertip ornament in the present invention.

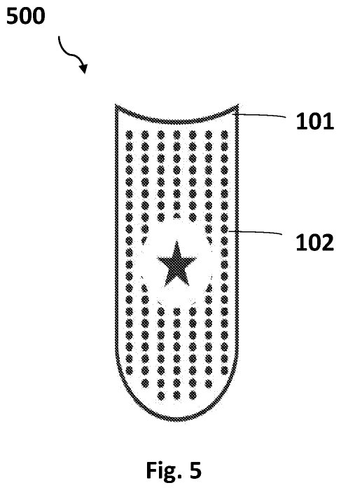

Still another embodiment of the present invention provides a gem embedded detachably attached fingertip ornament with plurality of round diamond and at least one star shaped diamond in the center. FIG. 5 shows the schematic view of fingertips ornament with plurality of round diamond and at least one star shaped diamond in the center.

The plurality of diamond in the present invention are of multiple size which is further comprised of round, star, pear, marquise, emerald, princess, baguette, heart, illusion, jade, HPHT (high-pressure high-temperature), cubic zirconia, lab grown, treated, fancy shape, moissanite, rose cut, oval, triangle, rectangle, hexagonal and octagonal etc. The color of the diamond can of D to Z, which provides the class of color of the diamond. The diamond in the present invention are of different shape and color, cut, grade and size which are as follows:

TABLE 1

| SR NO | SHAPE | COLOR | CUT | GRADE | SIZE |
|---|---|---|---|---|---|
| 1 | ROUND | D TO Z, | SINGLE | FL TO I3 | 0.6 mm to 1.2 mm |
| | | NATTS, LB, LC | | | |
| 2 | ROUND | D TO Z, | FULL | FL TO I3 | 0.6 mm to 1.2 mm |
| | | NATTS, LB, LC | | | |
| 3 | PEAR | D TO Z | PEAR | D TO I3 | 0.05 ct to 0.25 ct |
| 4 | MARQUISE | D TO Z | | IF TO I2 | 0.05 ct to 0.15 ct |
| 5 | EMERALD/ | D TO Z | | IF TO I2 | 0.05 ct to 0.10 ct |
| | ASSCHER | | | | |
| 6 | PRINCESS | D TO Z | | IF TO I2 | 0.05 ct to 0.25 ct |
| 7 | BUGGETE | D TO Z | | IF TO I2 | 0.01 ct to 0.20 ct |
| 8 | TAPPER | D TO Z | | IF TO I2 | 0.01 ct to 0.20 ct |
| | BUGGETE | | | | |
| 9 | HEART | D TO Z | | IF TO I2 | 0.04 ct to 0.20 ct |
| 10 | STAR | D TO Z | | IF TO I2 | 0.04 ct to 0.20 ct |
| 11 | ILLUSION | D TO Z | | IF TO I2 | 0.05 ct to 0.20 ct |
| 12 | FANCY | ALL | ALL | IF TO I2 | 0.01 ct to 0.20 ct |
| | SHAPE | | | | |
| 13 | JADE | ALL | ALL | IF TO I2 | Any size |
| 14 | COLOR | ALL | ALL | IF TO I2 | Any size |
| | GEMSTONES | | | | |
| 15 | LAB GROWN | D TO Z | ALL | IF TO I2 | Any size |
| 16 | TREATED | ALL COLOR | ALL | IF TO I3 | Any size |
| 17 | HPHT | D TO Z | ALL | IF TO I3 | Any size |
| 18 | Cubic Zirconia | D TO Z | ALL | FL TO I3 | Any size |
| 19 | Moissanite | D to Z | ALL | IF TO I3 | Any size |
| 20 | ROSE CUT | D TO Z | ALL | IF TO I3 | Any Size |
| 21 | OVAL | D TO Z | ALL | IF TO I3 | Any Size |
| 22 | TRINAGLE | ALL | ALL | IF TO I3 | Any Size |
| 23 | RECTANGLE | ALL | ALL | IF TO I3 | Any Size |
| 24 | HEXAGONAL | ALL | ALL | IF TO I3 | Any Size |
| 25 | OCTAGONAL | ALL | ALL | IF TO I3 | Any Size |

The metal plate in the present invention are of plurality of metal and have different weight which are as follows:

TABLE 2

| Sr. No. | Metals | Carats/Grades |
|---|---|---|
| 1 | White Gold | 9K to 24K |
| 2 | Rose Gold | 9K to 24K |
| 3 | Yellow Gold | 9K to 24K |
| 4 | Platinum | 850-900-999 |
| 5 | Silver | 800-925-999 |
| 6 | Bronze | Pb104/Pb1 |
| 7 | Stainless Steel | 301 to 316 |
| 8 | Iron | Gray/Ductile/White |
| 9 | Aluminum | 1100, 2011, 3001 |
| 10 | Copper | All |
| 11 | Titanium | CP, 6/4, and 6/6/2 |
| 12 | Acrylic | All |
| 13 | Plastic | All |
| 14 | Glass | All |

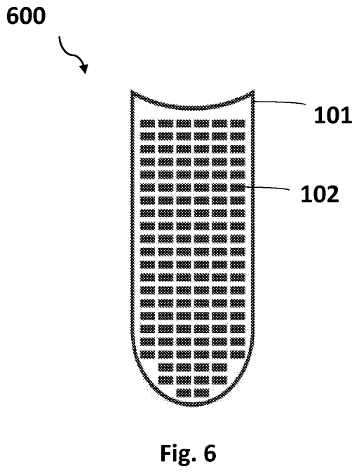

Another embodiment of the present invention provides a gem embedded detachably attached fingertip ornament with plurality of flat cuboidal shape diamond attach to it. FIG. 6 shows the schematic view of a fingertip ornament with plurality of flat cuboidal shape diamond.

The gem embedded detachably attached fingertip ornament attached on the fingertip using plurality of glue. The gem embedded detachably attached fingertip ornament can optionally fixed in the finger tips using very small clip like structure. The present invention also provides a fashionable, durable, self-design metallic fingertip nail ornament with plurality of gems mounted on it.

It is to be understood that the above description is intended to be illustrative, and not restrictive. For example, the above-discussed embodiments may be used in combination with each other. Many other embodiments will be apparent to those of skill in the art upon reviewing the above description.

The benefits and advantages which may be provided by the present invention have been described above with regard to specific embodiments. These benefits and advantages, and any elements or limitations that may cause them to occur or to become more pronounced are not to be construed as critical, required, or essential features of any or all of the embodiments.

While the present invention has been described with reference to particular embodiments, it should be understood that the embodiments are illustrative and that the scope of the invention is not limited to these embodiments. Many variations, modifications, additions and improvements to the embodiments described above are possible. It is contemplated that these variations, modifications, additions and improvements fall within the scope of the invention.

1. A gem embedded detachably attached fingertip ornament, comprising:
a plurality of metallic plates;
a plurality of glue types; and
a plurality of diamonds of different size and shape.

2. The gem embedded detachably attached fingertip ornament of claim 1, wherein said plurality of metallic plates are pseudo nail of different sizes and made up of gold, platinum, silver, bronze, iron, aluminum, copper, titanium, acrylic, plastic, glass, or a combination thereof.

3. The gem embedded detachably attached fingertip ornament of claim 1, wherein said plurality of glue types comprising aloe-vera glue, corn starch glue, natural glue, eyelash glue, glue made from vinyl acetate monomer, or combination thereof.

4. The gem embedded detachably attached fingertip ornament of claim 1, wherein said plurality of diamonds are of multiple size which further comprise of round, star, pear, marquise, emerald, princess, baguette, heart, illusion, jade, HPHT (high-pressure high-temperature), cubic zirconia, lab grown, treated, fancy shape, moissanite, rose cut, oval, triangle, rectangle, hexagonal and octagonal.

5. A process for designing a gem embedded detachably attached fingertip ornament, comprising:
i. scanning of nail of a user by a scanner from different direction;
ii. collecting a plurality of images from step (i) and producing a three dimensional image and/or nail by computer implemented method;
iii. transmitting said three dimensional images produced in step (ii) to a server;
iv. accessing said three dimensional image from said server by a designer user;
v. implementing a metallic plate on said three dimensional image of nail in computer implemented methods;
vi. implementing a plurality of designs, patterns and different shaped and sized gems on said metallic plate of step (v) in computer implemented methods;
vii. selecting a design, gem and metallic plate for said three dimensional image of nail in computer implemented methods;
viii. manufacturing of selected design and gem for a metallic plate;
ix. setting a diamond on said metallic plate;
x. adding glue to back side of said metallic plate after step (viii); and
xi. placing said gem on said metallic plate.

6. The process for designing said gem embedded detachably attached fingertip ornament of claim 6, wherein said server is a cloud server at which a plurality of three dimensional patterns, designs and three dimensional diamond images are stored.

7. The process for designing said gem embedded detachably attached fingertip ornament of claim 6, wherein said scanner can be laser scanner and any scanner with mobile objects.
